(19) United States
(12) Patent Application Publication
(10) Pub. No.: US 2025/0038431 A1
(43) Pub. Date: Jan. 30, 2025

(54) TERMINAL HAVING AN INSULATION DISPLACEMENT CONTACT

(71) Applicant: TE Connectivity Solutions GmbH, Schaffhausen (CH)

(72) Inventors: Galen M. Martin, Mechanicsburg, PA (US); Christopher Ryan Raybold, Middletown, PA (US); Jeremy Christin Patterson, Winston-Salem, NC (US); Adam Price Tyler, Rochester Hills, MI (US); Ryan David Hetrick, Carlisle, PA (US)

(21) Appl. No.: 18/666,963

(22) Filed: May 17, 2024

Related U.S. Application Data
(60) Provisional application No. 63/515,442, filed on Jul. 25, 2023.

(51) Int. Cl. H01R 4/2425; H01R 4/2454; H01R 4/2495; H01R 13/42; H01R 43/01

(52) U.S. Cl. CPC H01R 4/2425; H01R 4/2454; H01R 4/2495; H01R 13/42; H01R 43/01

(57) ABSTRACT

A terminal includes a terminal body extending between a mating end and a terminating end. The mating end has a mating interface. The terminating end has an insulation displacement contact. The insulation displacement contact includes a first contact element having a first blade and a second contact element having a second blade. The first blade faces the second blade across a cable slot configured to receive a cable. The terminal includes a contact support extending along the insulation displacement contact. The contact support holds the first contact element relative to the second contact element.

### CROSS REFERENCE TO RELATED APPLICATIONS

This application claims the benefit of U.S. Provisional Application No. 63/515,442, filed 25 Jul. 2023, the subject matter of which is herein incorporated by reference in its entirety.

### BACKGROUND OF THE INVENTION

The subject matter herein relates generally to terminals for electrical connectors.

Electrical connectors typically hold terminals, which are connected to ends of cables. The terminals may be connected to the cables by solder, crimp connections or other types of connections, such as insulation displacement terminations. Insulation displacement contacts electrically connect to a conductor of the cable by piercing an insulation layer around the conductor. The insulation displacement contact has opposite blades each with a cutting edge that pierce the insulation layer and electrically connect to the conductor. However, known insulation displacement contacts are not without disadvantages. For instance, the blades may be spread apart when the cable is plugged into the cable slot between the blades leading to a poor electrical connection. Additionally, when the blades are spread apart, the width of the terminal increases, which may cause difficulty in assembling the terminals to the housing of the electrical connector. For example, the terminals may be too wide to fit in the openings or channels in the housing.

A need exists for a reliable insulation displacement contact.

### BRIEF DESCRIPTION OF THE INVENTION

In one embodiment, a terminal is provided and includes a terminal body extending between a mating end and a terminating end. The mating end has a mating interface. The terminating end has an insulation displacement contact. The insulation displacement contact includes a first contact element having a first blade and a second contact element having a second blade. The first blade faces the second blade across a cable slot configured to receive a cable. The terminal includes a contact support extending along the insulation displacement contact. The contact support holds the first contact element relative to the second contact element.

In another embodiment, an electrical connector is provided and includes a housing that has a mating end and a cable end. The housing includes terminal channels. The electrical connector includes terminals received in the corresponding terminal channels of the housing. Each terminal includes a terminal body extending between a mating end and a terminating end. The mating end has a mating interface. The terminating end has an insulation displacement contact. The insulation displacement contact includes a first contact element that has a first blade and a second contact element that has a second blade. The first blade faces the second blade across a cable slot configured to receive a cable. The terminal includes a contact support extending along the insulation displacement contact. The contact support holds the first contact element relative to the second contact element. The insulation displacement contact and the contact support are received in the corresponding terminal channel of the housing.

In a further embodiment, a terminal is provided and includes a terminal body extending between a mating end and a terminating end. The mating end has a mating interface. The terminating end has an insulation displacement contact. The insulation displacement contact includes a first contact element and a second contact element that has a cable slot therebetween configured to receive a cable. The first contact element includes a first lateral wall and first blades extending from the first lateral wall toward the second contact element. The second contact element includes a second lateral wall and second blades extending from the second lateral wall toward the first contact element. The second blades are aligned with the corresponding first blades across the cable slot. The first and second blades are configured to pierce an insulator of the cable to electrically connect to a conductor of the cable. The terminal includes a contact support extending along the insulation displacement contact. The contact support includes a first support element extending along the first lateral wall and a second support element extending along the second lateral wall. The first and second support elements holds the first and second lateral walls relative to each other to resist widening of the cable slot.

In a further embodiment, a terminal is provided and includes a terminal body extending between a mating end and a terminating end. The mating end has a mating interface. The terminating end has an insulation displacement contact. The insulation displacement contact includes a first contact element and a second contact element has a cable slot therebetween configured to receive a cable. The insulation displacement contact has an exterior opposite the cable slot. The first contact element includes a first lateral wall and first blades extending from the first lateral wall toward the second contact element. The second contact element includes a second lateral wall and second blades extending from the second lateral wall toward the first contact element. The second blades are aligned with the corresponding first blades across the cable slot. The first and second blades are configured to pierce an insulator of the cable to electrically connect to a conductor of the cable. The insulation displacement contact has a base wall between the first and second lateral walls. The terminal includes a contact support that has a cladding layer clad to the exterior of the insulation displacement contact. The cladding layer extends along the first contact element and the second contact element. The cladding layer includes a first support element extending along the first lateral wall and a second support element extending along the second lateral wall. The cladding layer includes a cover element extending along the base wall. The first and second support elements holds the first and second lateral walls relative to each other to resist widening of the cable slot.

### BRIEF DESCRIPTION OF THE DRAWINGS

FIG. 1 is a rear perspective view of an electrical connector and a plurality of terminals in accordance with an exemplary embodiment.

FIG. 2 is a perspective view of a portion of the terminal showing the terminating end in accordance with an exemplary embodiment terminated to the cable.

FIG. 3 is an exploded view of a portion of the terminal showing the terminating end in accordance with an exemplary embodiment.

FIG. 4 is a perspective view of a portion of the terminal showing the cable poised for loading into the terminating end in accordance with an exemplary embodiment.

FIG. 5 is an exploded view of a portion of the terminal showing the terminating end in accordance with an exemplary embodiment.

FIG. 6 is a perspective view of a portion of the terminal showing the cable poised for loading into the terminating end in accordance with an exemplary embodiment.

FIG. 7 is a perspective view of a portion of the terminal showing the terminating end in accordance with an exemplary embodiment terminated to the cable.

FIG. 8 is an exploded view of a portion of the terminal showing the terminating end in accordance with an exemplary embodiment.

FIG. 9 is a perspective view of a portion of the terminal showing the cable poised for loading into the terminating end in accordance with an exemplary embodiment.

FIG. 10 is a perspective view of a portion of the terminal showing the terminating end in accordance with an exemplary embodiment terminated to the cable.

FIG. 11 is an exploded view of a portion of the terminal showing the terminating end in accordance with an exemplary embodiment.

FIG. 12 is an assembled view of a portion of the terminal showing the terminating end in accordance with an exemplary embodiment.

FIG. 13 is a perspective view of a portion of the terminal showing the terminating end in accordance with an exemplary embodiment.

### DETAILED DESCRIPTION OF THE INVENTION

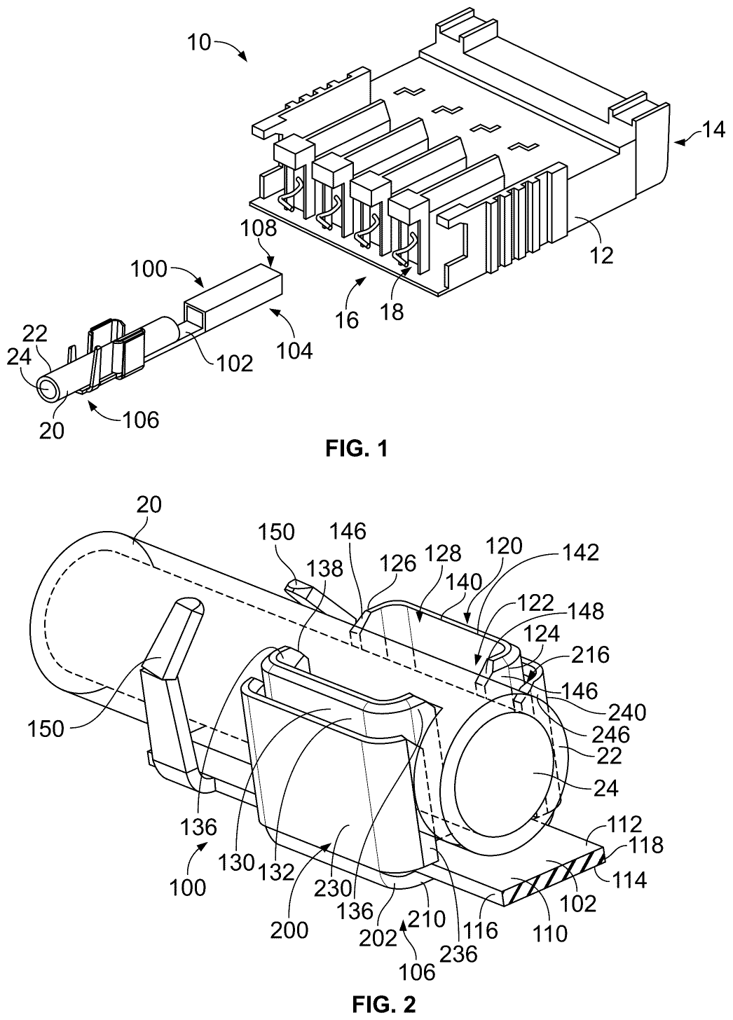

FIG. 1 is a rear perspective view of an electrical connector 10 and a plurality of terminals 100 in accordance with an exemplary embodiment. FIG. 1 shows 1 of the terminals 100 poised for loading into a housing 12 of the electrical connector 10. The terminals 100 are terminated to ends of cables 20. In an exemplary embodiment, the terminals 100 include insulation displacement terminations to the cables 20. The electrical connector 10 is provided as a nonlimiting example of a type of connector that utilizes terminals 100 with insulation displacement terminations. In an exemplary embodiment, the cables 20 may be large diameter cables. The terminals 100 include support elements for supporting the insulation displacement termination to ensure a reliable electrical connection to the 20.

The housing 12 extends between a mating end 14 and a cable end 16. Optionally, the mating end 14 may be located at a front of the housing and the cable and 16 may be located at a rear of the housing. However, in alternative embodiments, the electrical connector 10 may be a right angle connector having the cable end 16 oriented perpendicular to the mating end 14. The housing 12 includes terminal channels 18 that receive the terminals 100. The terminals 100 may be loaded into the terminal channels 18 through the rear of the housing 12. The cables 20 extend from the cable and 16. The housing 12 may include latches to hold the terminals 100 in the terminal channels 18. In other various embodiments, clips or other securing features may be used to retain the terminals 100 in the terminal channels 18. In the illustrated embodiment, the housing 12 includes separating walls between the terminal channels 18 that are used to position the terminals 100 in the terminal channels 18. The terminal channels 18 are sized and shaped to receive the terminals 100. In the illustrated embodiment, the terminal channels 18 are rectangular shaped having a height and a width to accommodate the terminals 100. In an exemplary embodiment, the terminals 100 are low profile to allow use of small terminal channels 18 and thus reduce the overall size of the housing 12. For example, the terminals 100 may have a height and a width approximately equal to (for example, only slightly larger than) the diameter of the cable 20. As such, the terminal channels 18 have a height and width approximately equal to the diameter of the cable 20.

Each terminal 100 has a terminal body 102 that extends longitudinally between a mating end 104 and a terminating end 106. The mating end 104 has a mating interface 108 configured to be mated to a mating electrical connector. For example, the mating end 104 may be located at the mating end 14 of the housing 12 for electrical connection with the mating electrical connector. Various types of mating interfaces 108 may be provided at the mating end 104. For example, the terminal 100 may include a pin or a socket at the mating end 104. In other various embodiments, the terminal 100 may include a blade, a spring beam, a tuning fork contact, a box contact, or another type of mating interface.

The terminal 100 is terminated to the cable 20 at the terminating end 106. For example, the terminal 100 includes an insulation displacement contact at the terminating end 106 configured to be mechanically and electrically connected to the cable 20 by an insulation displacement termination. For example, the cable 20 is pressed into a cable slot in the terminal 100 where blades pierce insulation 22 of the cable 20 to electrically connect to a conductor 24 of the cable 20. The conductor 24 may be a stranded wire or a solid conductor. The insulation 22 may be a jacket or other insulating material surrounding the conductor 24.

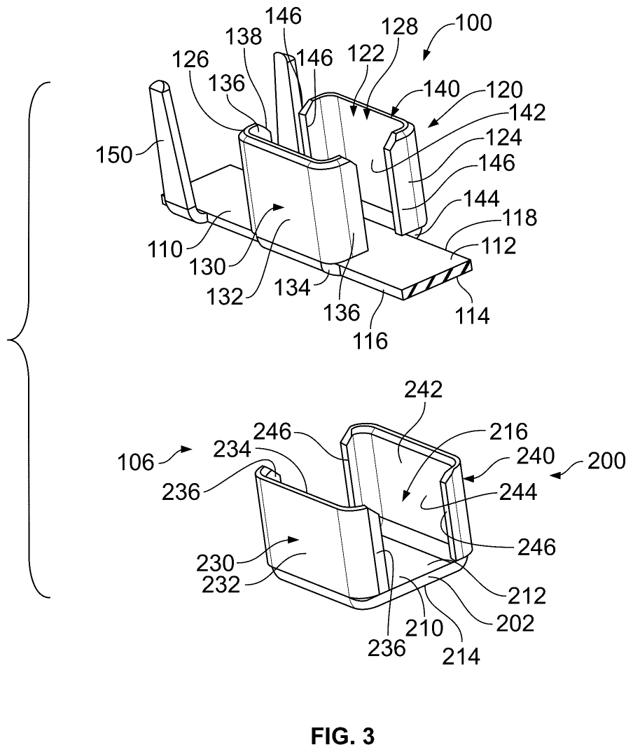

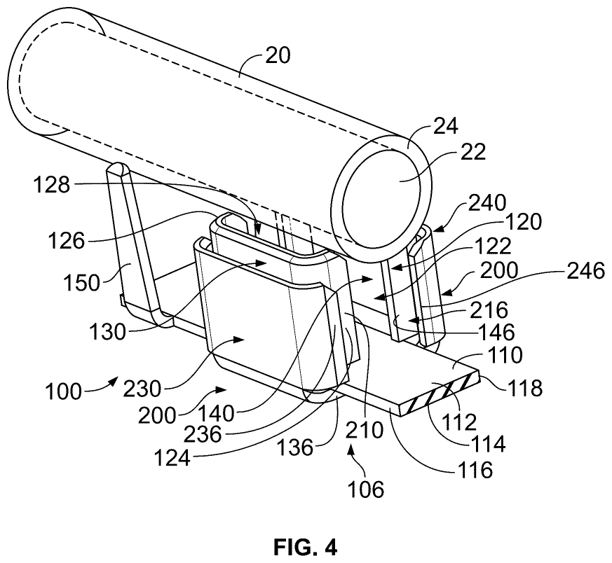

FIG. 2 is a perspective view of a portion of the terminal 100 showing the terminating end 106 in accordance with an exemplary embodiment terminated to the cable 20. FIG. 3 is an exploded view of a portion of the terminal 100 showing the terminating end 106 in accordance with an exemplary embodiment. FIG. 4 is a perspective view of a portion of the terminal 100 showing the cable poised for loading into the terminating end 106 in accordance with an exemplary embodiment.

The terminal body 102 includes a base wall 110 having an upper surface 112 and a lower surface 114. The base wall 110 extends between opposite edges 116, 118. In an exemplary embodiment, the base wall 110 is generally planar. The mating contact (FIG. 1) may extend from the base wall 110 at a front of the terminal 100. In an exemplary embodiment, the terminal body 102 is stamped and formed with the components were portions of the terminal 100 being made from a flat sheet of metal. In various embodiments, the terminal body 102 is manufactured from a highly conductive metal to create an electrical path between the cable 20 and the mating electrical component. For example, the terminal body 102 may be manufactured from a copper or copper alloy material. However, the terminal body 1 2 may be manufactured from other metal materials in alternative embodiments.

The terminal 100 includes an insulation displacement contact 120 at the terminating end 106. The terminal 100 is mechanically and electrically connected to the cable 20 at the insulation displacement contact 120. In an exemplary embodiment, the insulation displacement contact 120 includes a cable slot 122 that receives the cable 20. The illustrated embodiment, the insulation displacement contact 120 is box shaped having an elongated cable slot 122 that receives the cable 20. The insulation displacement contact 120 is mechanically and electrically connected to the cable 20 at different longitudinal points along the cable 20, such as at a front 124 and a rear 126 of the insulation displacement contact 120. In an exemplary embodiment, the insulation displacement contact 120 includes an opening 128 at the top of the insulation displacement contact 120 generally opposite the base wall 110. The cable 20 is loaded into the cable slot 122 through the opening 128.

The insulation displacement contact 120 includes a first contact element 130 and a second contact element 140. The first contact element 130 is provided at a first side of the cable slot 122 and the second contact element 140 is provided at a second side of the cable slot 122. The cable 20 is captured between the first contact element 130 and the second contact element 140. In an exemplary embodiment, the first and second contact elements 130, 140 are configured to pierce the insulation 22 of the cable 20 to interface with the conductor 24.

The first contact element 130 includes a first lateral wall 132 and a first connecting wall 134 connecting the first lateral wall 132 to the base wall 110. In the illustrated embodiment, the first connecting wall 134 is bent 900 to orient the first lateral wall 132 perpendicular to the base wall 110. The first lateral wall 132 extends along the cable slot 122, such as parallel to the longitudinal axis/mating axis of the terminal 100. In other various embodiments, the cable slot 122 may be oriented at other orientations, such as perpendicular to the mating axis of the terminal 100. The first lateral wall 132 extends between the front 124 and the rear 126 of the insulation displacement contact 120. In an exemplary embodiment, one or more first blades 136 extend from the first lateral wall 132 inward toward the second contact element 140. The blades 136 may be oriented perpendicular to the lateral wall 132. The blades 136 may be provided at the front 124 and/or the rear 126. The blades 136 are configured to pierce the insulation 22 of the cable 20 to electrically connect to the conductor 24. The blades 136 may be shaved or thinned to more easily pierce the insulation 22. The blades 136 may include lead-in surfaces 138 at the upper edges to guide the cable 20 into the cable slot 122.

The second contact element 140 includes a second lateral wall 142 and a second connecting wall 144 connecting the second lateral wall 142 to the base wall 110. In the illustrated embodiment, the second connecting wall 144 is bent 900 to orient the second lateral wall 142 perpendicular to the base wall 110. The second lateral wall 142 extends along the cable slot 122, such as parallel to the longitudinal axis/mating axis of the terminal 100. In other various embodiments, the cable slot 122 may be oriented at other orientations, such as perpendicular to the mating axis of the terminal 100. The second lateral wall 142 extends between the front 124 and the rear 126 of the insulation displacement contact 120. In an exemplary embodiment, one or more second blades 146 extend from the second lateral wall 142 inward toward the second contact element 140. The blades 146 may be oriented perpendicular to the lateral wall 142. The blades 146 may be provided at the front 124 and/or the rear 126. The blades 146 are configured to pierce the insulation 22 of the cable 20 to electrically connect to the conductor 24. The blades 146 may be shaved or thinned to more easily pierce the insulation 22. The blades 146 may include lead-in surfaces 148 at the upper edges to guide the cable 20 into the cable slot 122. In an exemplary embodiment, the blades 146 of the second contact element 140 are aligned with the corresponding blades 136 of the first contact element 130 on opposite sides of the cable slot 122.

In an exemplary embodiment, the insulation displacement contact 120 is generally box shaped defined by the base wall 110 at the bottom, the lateral walls 132, 142 at opposite sides, the blades 136, 146 at the front and rear, and the opening 128 at the top. The cable 20 is configured be received in the cable slot 122 through the opening 128 between the contact elements 130, 140. The blades 136, 146 at the front 124 and the rear 126 displace the insulation 22 to interface with the conductor 24 to electrically connect the terminal 100 to the cable 20.

In an exemplary embodiment, the terminal 100 includes crimp arms 150 extending from the base wall 110. The crimp arms 150 are configured to be folded or crimped to the insulation 22 of the cable 20 to hold the cable 20 relative to the insulation displacement contact 120. The crimp arms 150 may be located forward of the insulation displacement contact 120 and/or rearward of the insulation displacement contact 120 the crimp arms 150 may be located at the first side and/or the second side of the cable 20.

In an exemplary embodiment, the terminal 100 includes a contact support 200. The contact support 200 is used to support the contact elements 130, 140. In an exemplary embodiment, the contact support 200 resists widening of the cable slot 122 when the cable 20 is plugged into the cable slot 122. For example, outward pressure on the contact elements 130, 140 by the cable 20 is resisted by the contact support 200. The contact support 200 holds the natural (for example, parallel) orientations of the contact elements 130, 140 to maintain the profile of the terminal 100 for properly loading the terminal 100 into the terminal channel 18 in the housing 12 of the electrical connector 10.

In an exemplary embodiment, the contact support 200 is a rigid component. For example, the contact support 200 is manufactured from a material having a high modulus of elasticity (for example, higher modulus of elasticity than the material of the terminal body 102). In various embodiments, the contact support 200 is manufactured from a steel material, such as a stainless steel, a carbon steel, a nickel steel, a chromium-molybdenum steel, or another steel alloy. The contact support may be manufactured from another high strength material. In various embodiments, the contact support 200 may be made from a thicker material than the terminal body 102 to increase the strength, rigidity and stiffness of the contact support 200 compared to the terminal body 102 to provide the necessary support for the insulation displacement contact 120.

In an exemplary embodiment, the contact support 200 includes a cover wall 210 extending between a first support element 230 and a second support element 240. The cover wall 210 positions the support elements 230, 240 relative to each other. The cover wall 210 includes an inner surface 212 and an outer surface 214. The inner surface 212 faces a cable cavity 216 configured to receive the cable 20. The support elements 230, 240 are provided on opposite sides of the cable cavity 216. The contact support 200 is configured be positioned outside of the insulation displacement contact 120. For example, the insulation displacement contact 120 may be received in the cable cavity 216 of the contact support 200.

The first support element 230 includes a first outer support 232 having an inner surface 234 that faces the cable cavity 216. In various embodiments, the first outer support 232 may be a support wall. The first outer support 232 is configured to extend along the first lateral wall 132 of the first contact element 130. The first outer support 232 is used to hold the position of the first lateral wall 132 when the cable 20 is plugged into the cable slot 122. In an exemplary embodiment, the first support element 230 includes support fingers 236 extending from the outer support 232. The support fingers 236 are configured to extend along the first blades 136 of the first contact element 130. The support fingers 236 may support the first blades 136. The support fingers 236 may engage the cable 20 to mechanically and/or electrically connect to the cable 20.

The second support element 240 includes a second outer support 242 having an inner surface 244 that faces the cable cavity 216. In various embodiments, the second outer support 242 may be a support wall. The second outer support 242 may extend parallel to the first outer support 232. The second outer support 242 is configured to extend along the second lateral wall 142 of the second contact element 140. The second outer support 242 is used to hold the position of the second lateral wall 142 when the cable 20 is plugged into the cable slot 122. In an exemplary embodiment, the second support element 240 includes support fingers 246 extending from the outer support 242. The support fingers 246 are configured to extend along the second blades 146 of the second contact element 140. The support fingers 246 may support the second blades 146. The support fingers 246 may engage the cable 20 to mechanically and/or electrically connect to the cable 20.

In an exemplary embodiment, the contact support 200 is a stamped and formed part having a body 202, which may be a plate-like body. The contact support 200 is stamped from a metal material, such as a steel material and formed into a particular shape. In the illustrated embodiment, the contact support 200 is U-shaped having the cover wall 210 and the support elements 230, 240 extending from opposite sides of the cover wall 210. The contact support 200 may have other shapes in alternative embodiments. In an exemplary embodiment, the contacts or 200 has a thickness, which is based on the thickness of the metal material that the contact support 200 is stamped from.

In an exemplary embodiment, the contact support 200 is separate and discrete from the terminal body 102. The contact support 200 is coupled to the insulation displacement contact 120 of the terminal body 102. In an exemplary embodiment, the contact support 200 is coupled to the bottom of the terminal 100. For example, the contact support 200 is coupled to the terminal body 102 from below such that the cover wall 210 covers the lower surface 114 of the base wall 110. The support elements 230, 240 covers the outer surfaces of the lateral walls 132, 142. In various embodiments, the contact support 200 is pre-assembled to the insulation displacement contact 120 prior to loading the cable 20 into the cable slot 122. The support elements 230, 240 support the contact elements 130, 140, respectively, as the cable 20 is loaded into the cable slot 122. The contact support 200 resists spreading apart of the contact elements 130, 140 when the cable 20 is plugged into the cable slot 122. For example, the support elements 230, 240 rigidly hold the contact elements 130, 140 to maintain the slot width of the cable slot 122 as the cable 20 is plugged into the cable slot 122. In alternative embodiments, the contact support 200 is assembled to the insulation displacement contact 120 after the cable 20 is plugged into the cable slot 122. For example, the contact support 200 is plugged onto the terminal body 102 to press the contact elements 130, 140 inward toward the cable 20 to maintain the mechanical and electrical connection between the contact elements 130, 140 and the conductor 24 of the cable 20.

When assembled, the contact support 200 increases the overall profile of the terminal 100. For example, the cover wall 210 increases the overall height of the terminal 100. However, the overall height of the terminal 100 is only increased by the thickness of the material of the contact support 200, which is relatively thin to have very little effect on the overall height. For example, the contact support 200 increases the overall height by less than 10%. The support elements 230, 240 increase the overall width of the terminal 100. However, the overall width of the terminal 100 is only increased by twice the thickness of the material of the contact support 200, which is very little effect on the overall width. For example, the contact support 200 increases the overall width by less than 10%.

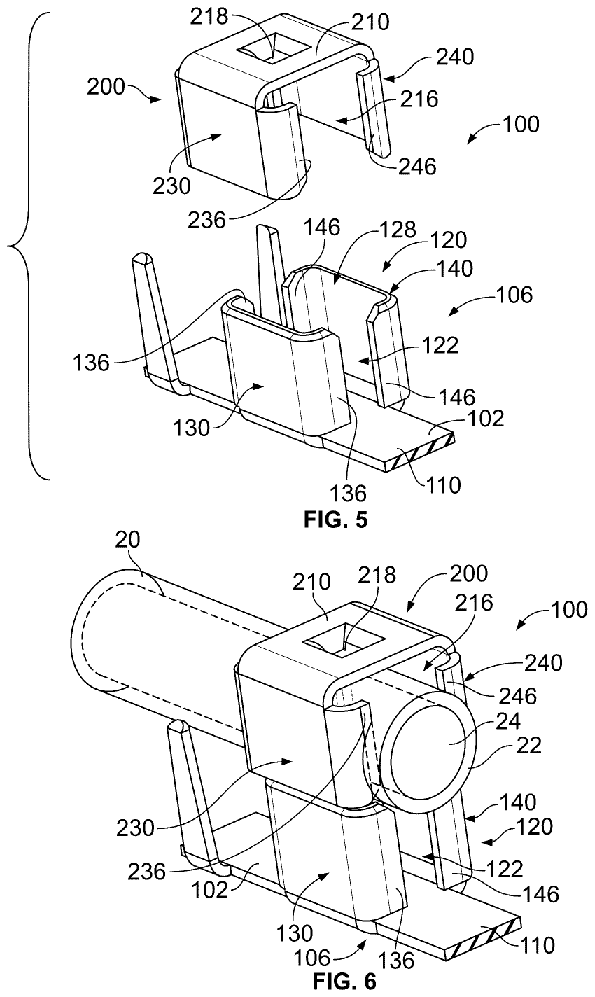

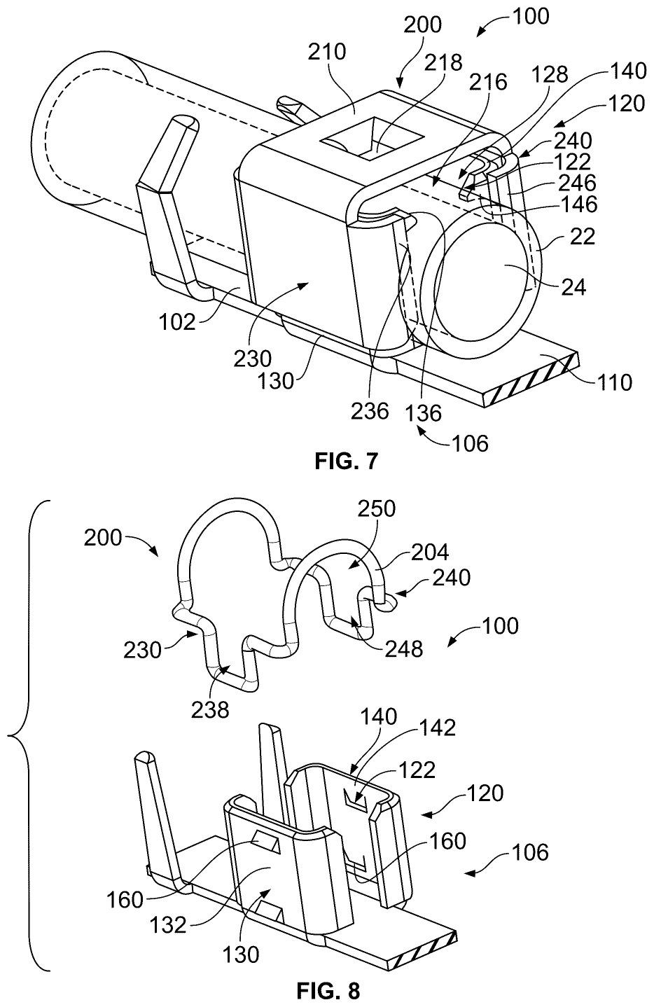

FIG. 5 is an exploded view of a portion of the terminal 100 showing the terminating end 106 in accordance with an exemplary embodiment. FIG. 6 is a perspective view of a portion of the terminal 100 showing the cable poised for loading into the terminating end 106 in accordance with an exemplary embodiment. FIG. 7 is a perspective view of a portion of the terminal 100 showing the terminating end 106 in accordance with an exemplary embodiment terminated to the cable 20. In the illustrated embodiment, the contact support 200 is coupled to the top of the insulation displacement contact 120. For example, the contact support 200 is loaded onto the top of the insulation displacement contact 120 to cover the opening 128. The cover wall 210 covers the opening 128 while the support elements 230, 240 extend along the contact elements 130, 140.

In an exemplary embodiment, the cover wall 210 includes a protrusion 218 extending into the cable cavity 216. The protrusion 218 is configured to engage the cable 20 to position the cable 20 in the cable slot 122. The protrusion 218, which is located above the cable 20, presses the cable 20 into the cable slot 122 toward the base wall 110.

In an exemplary embodiment, the contact support 200 is used as a stuffer to load the cable 20 into the cable slot 122. For example, the cable 20 may be initially loaded into the cable cavity 216 of the contact support 200 between the support fingers 236, 246. In various embodiments, the support fingers 236, 246 may pierce the insulation 22 and engage the conductor 24. Optionally, a width of the gap between the support fingers 236, 246 may be approximately equal to a diameter of the conductor 24. In various embodiments, the width of the gap between the support fingers 236, 246 may be slightly narrower than the diameter of the conductor 24 such that the conductor 24 is slightly compressed or deformed between the support fingers 236, 246. In other various embodiments, the width of the gap between the support fingers 236, 246 may be slightly wider than the diameter of the conductor 24 such that the support fingers 236, 246 do not compress the conductor 24. In alternative embodiments, the width of the gap between the support fingers 236, 246 may be approximately equal to the diameter of the insulation 22 such that the support fingers 236, 246 do not pierce the insulation 22. During assembly, as the contact support 200 is coupled to the insulation displacement contact 120, the contact support 200 loads the cable 20 into the insulation displacement contact 120. The cable 20 is loaded into the cable slot 122 to engage the contact elements 130, 140. The blades 136, 146 pierce the insulation 22 and engage the conductor 24 has the contact support 200 loads the cable 20 into the cable slot 122. As the contact support 200 is coupled to the insulation displacement contact 120, the support elements 230, 240 support the contact elements 130, 140 and resist spreading door opening of the cable slot 122 as the cable 20 is loaded into the cable slot 122. In alternative embodiments, the contact support 200 is assembled to the insulation displacement contact 120 after the cable 20 is plugged into the cable slot 122. For example, the contact support 200 is plugged onto the terminal body 102 to press the contact elements 130, 140 inward toward the cable 20 to maintain the mechanical and electrical connection between the contact elements 130, 140 and the conductor 24 of the cable 20.

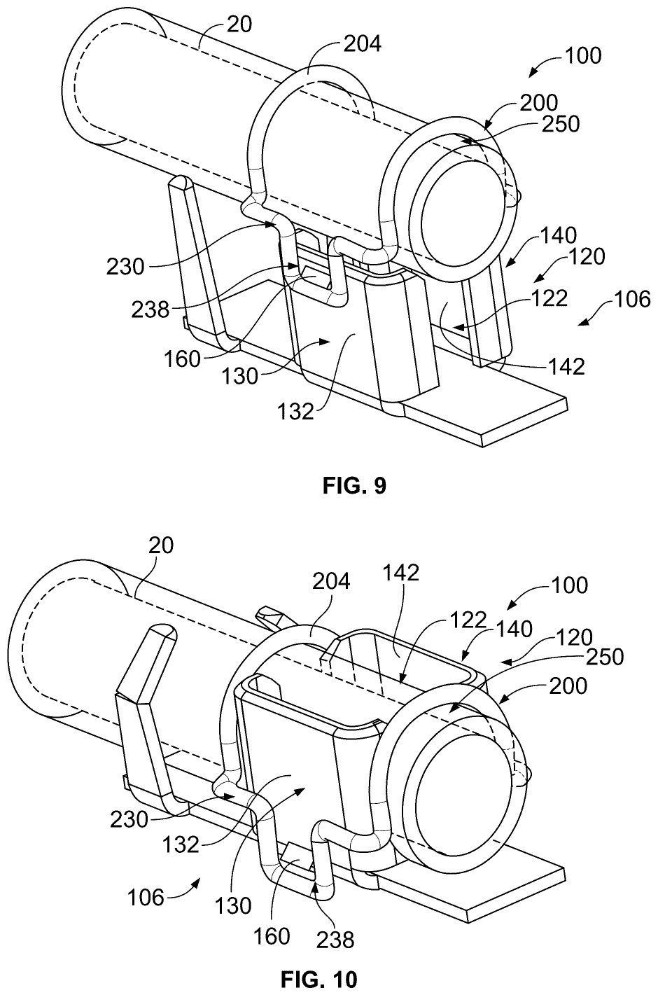

FIG. 8 is an exploded view of a portion of the terminal 100 showing the terminating end 106 in accordance with an exemplary embodiment. FIG. 9 is a perspective view of a portion of the terminal 100 showing the cable poised for loading into the terminating end 106 in accordance with an exemplary embodiment. FIG. 10 is a perspective view of a portion of the terminal 100 showing the terminating end 106 in accordance with an exemplary embodiment terminated to the cable 20. In the illustrated embodiment, the contact support 200 is a spring wire. The contact support 200 includes a wire body 204, such as a round-stock wire that is formed into a predetermined shape.

In an exemplary embodiment, the cover portion of the contact support 200 forms a cable cradle 250 that receives the cable 20. The cable cradle 250 may be rounded to follow a curvature of the cable 20. The contact support 200 includes the first and second support elements 230, 240 extending on opposite sides of the contact support 200. The cable cradle 250 connects the first and second support elements 230, 240. The support elements 230, 240 are configured to extend along the lateral walls 132, 142 of the contact elements 130, 140. The support elements 230, 240 are used to hold the positions of the lateral walls 132, 142 when the cable 20 is plugged into the cable slot 122. In an exemplary embodiment, the support elements 230, 240 include latch pockets 238, 248, respectively. The latch pockets 238, 248 receive latches 160 extending from the lateral walls 132, 142. The latches 160 secure the contact support 200 to the insulation displacement contact 120. In the illustrated embodiment, multiple latches 160 are provided on each lateral wall 132, 142 at different vertical positions to hold the contact support 200 at different vertical positions, such as in an elevated or pre-stage position and in a lowered or securing position. The contact support 200 may be used to load the cable 20 into the cable slot 122. For example, the contact support 200 is pressed downward to load the cable 20 into the cable slot 122. The support elements 230, 240 resists spreading apart of the contact elements 130, 140 when the cable 20 is plugged into the cable slot 122. For example, the support elements 230, 240 rigidly hold the contact elements 130, 140 to maintain the slot width of the cable slot 122 as the cable 20 is plugged into the cable slot 122.

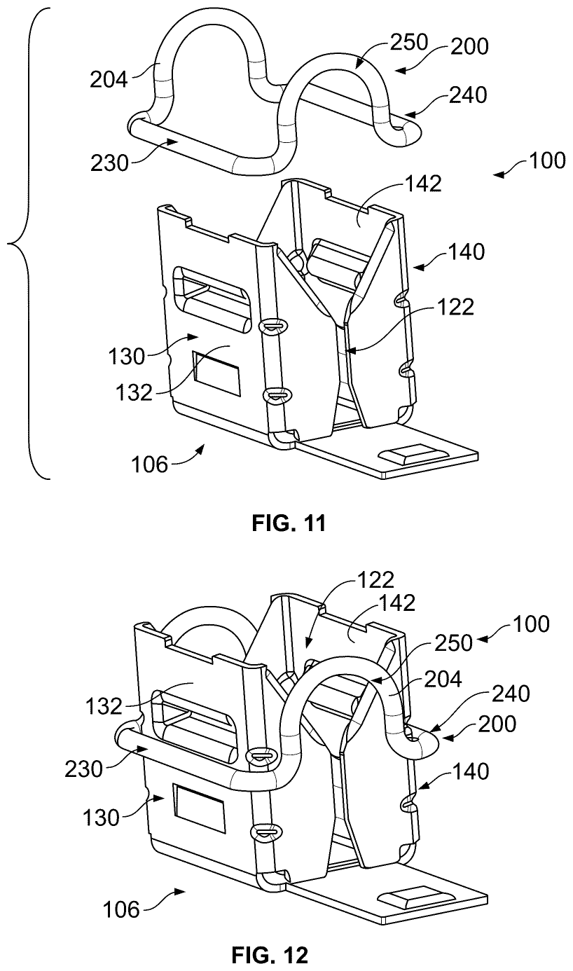

FIG. 11 is an exploded view of a portion of the terminal 100 showing the terminating end 106 in accordance with an exemplary embodiment. FIG. 12 is an assembled view of a portion of the terminal 100 showing the terminating end 106 in accordance with an exemplary embodiment. In the illustrated embodiment, the contact support 200 is a spring wire forming the wire body 204 into a predetermined shape. The contact support 200 includes the cable cradle 250 that receives the cable 20. The contact support 200 includes the first and second support elements 230, 240 extending on opposite sides of the contact support 200. The support elements 230, 240 are configured to extend along the lateral walls 132, 142 of the contact elements 130, 140. The support elements 230, 240 are used to hold the positions of the lateral walls 132, 142 when the cable 20 is plugged into the cable slot 122. The support elements 230, 240 resists spreading apart of the contact elements 130, 140 when the cable 20 is plugged into the cable slot 122. For example, the support elements 230, 240 rigidly hold the contact elements 130, 140 to maintain the slot width of the cable slot 122 as the cable 20 is plugged into the cable slot 122.

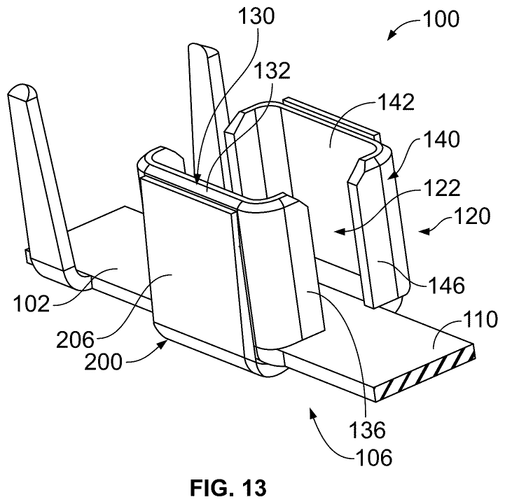

FIG. 13 is a perspective view of a portion of the terminal 100 showing the terminating end 106 in accordance with an exemplary embodiment. In the illustrated embodiment, the contact support 200 is a cladding on the insulation displacement contact 120. The contact support 200 includes a cladding layer 206. The cladding layer 206 provides rigidity to the insulation displacement contact 120. The cladding layer 206 resists spreading apart of the contact elements 130, 140 of the insulation displacement contact 120 when the cable 20 is plugged into the cable slot 122.

In an exemplary embodiment, the cladding layer 206 is cladded directly to the exterior surface of the insulation displacement contact 120. The cladding layer 206 is a different material from the terminal body 102. For example, the terminal body 102 may be a copper or copper alloy material and the cladding layer 206 may be a steel material, such as stainless steel. The cladding layer 206 may be bonded to the terminal body 102, such as by pressing or rolling the metal sheets together under high pressure. The cladding layer 206 may be selectively applied to the terminal body 102, such as along the base wall 110, the first contact element 130 and the second contact element 140. In an exemplary embodiment, the cladding layer 206 may be applied to the lateral walls 132, 142. Optionally, the cladding layer 206 may be applied to the blades 136, 146.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A terminal comprising:
a terminal body extending between a mating end and a terminating end, the mating end having a mating interface, the terminating end having an insulation displacement contact;
the insulation displacement contact including a first contact element having a first blade and a second contact element having a second blade, the first blade facing the second blade across a cable slot configured to receive a cable; and
a contact support extending along the insulation displacement contact, the contact support holding the first contact element relative to the second contact element.

2. The terminal of claim 1, wherein the terminal body is manufactured from a first material and the contact support is manufactured from a second material having a higher modulus of elasticity than the first material.

3. The terminal of claim 1, wherein the contact support is separate and discrete from the insulation displacement contact, the contact support being coupled to the insulation displacement contact.

4. The terminal of claim 1, wherein the contact support resists widening of the cable slot.

5. The terminal of claim 1, wherein the contact support extends along an outer surface of the first contact element and an outer surface of the second contact element.

6. The terminal of claim 1, wherein the first contact element includes a third blade and a first lateral wall between the first blade and the third blade, the second contact element including a fourth blade and a second lateral wall between the second blade and the fourth blade, the contact support extending along the first lateral wall and the second lateral wall.

7. The terminal of claim 6, wherein the contact support extends along the first blade, the second blade, the third blade, and the fourth blade.

8. The terminal of claim 6, wherein the insulation displacement contact includes a base wall between the first lateral wall and the second lateral wall, the insulation displacement contact including an opening at the top between the first lateral wall and the second lateral wall opposite the base wall, the contact support extending along the base wall.

9. The terminal of claim 6, wherein the insulation displacement contact includes a base wall between the first lateral wall and the second lateral wall, the insulation displacement contact including an opening at the top between the first lateral wall and the second lateral wall opposite the base wall, the contact support extending along the opening.

10. The terminal of claim 6, wherein the terminal body extends along a longitudinal axis between the mating end and the terminating end, the first and second lateral walls extending parallel to the longitudinal axis, the first and second blades being longitudinally aligned with each other along the longitudinal axis and extending perpendicular to the longitudinal axis, the third and fourth blades being longitudinally aligned with each other along the longitudinal axis and extending perpendicular to the longitudinal axis.

11. The terminal of claim 1, wherein the contact support is U-shaped having a first support element extending along the first contact element, a second support element extending along the second contact element, and a cover element extending between the first support element and the second support element, the cover element extending along one of a top or a bottom of the insulation displacement contact.

12. The terminal of claim 1, wherein the contact support includes a thickness, the contact support adding no more height to the terminal than the thickness when the contact support is coupled to the insulation displacement contact.

13. The terminal of claim 1, wherein the contact support include support fingers engaging the cable to support the cable relative to the terminal body.

14. The terminal of claim 13, wherein the support fingers pierce an insulator of the cable.

15. The terminal of claim 13, wherein the support fingers are separated by a distance greater than a width of the cable slot between the first and second blades.

16. The terminal of claim 1, wherein the terminal body includes crimp arms crimped to the cable to hold the cable relative to the insulation displacement contact.

17. The terminal of claim 1, wherein the contact support is a cladding on an outer surface of the insulation displacement contact.

18. The terminal of claim 1, wherein the contact support is a wire formed to include a cable cradle configured to receive the cable.

19. The terminal of claim 18, wherein the wire includes a first support element extending along the first contact element and a second support element extending along the second contact element.

20. An electrical connector comprising:
a housing having a mating end and a cable end, the housing including terminal channels;
terminals received in the corresponding terminal channels of the housing, each terminal including a terminal body extending between a mating end and a terminating end, the mating end having a mating interface, the terminating end having an insulation displacement contact, the insulation displacement contact including a first contact element having a first blade and a second contact element having a second blade, the first blade facing the second blade across a cable slot configured to receive a cable, the terminal including a contact support extending along the insulation displacement contact, the contact support holding the first contact element relative to the second contact element;
wherein the insulation displacement contact and the contact support are received in the corresponding terminal channel of the housing.

21. A terminal comprising:
a terminal body extending between a mating end and a terminating end, the mating end having a mating interface, the terminating end having an insulation displacement contact;
the insulation displacement contact including a first contact element and a second contact element having a cable slot therebetween configured to receive a cable, the first contact element including a first lateral wall and first blades extending from the first lateral wall toward the second contact element, the second contact element including a second lateral wall and second blades extending from the second lateral wall toward the first contact element, the second blades being aligned with the corresponding first blades across the cable slot, the first and second blades configured to pierce an insulator of the cable to electrically connect to a conductor of the cable; and
a contact support extending along the insulation displacement contact, the contact support including a first support element extending along the first lateral wall and a second support element extending along the second lateral wall, the first and second support elements holding the first and second lateral walls relative to each other to resist widening of the cable slot.

22. The terminal of claim 21, wherein the contact support is stamped and formed into a U-shaped element having a cover wall extending between the first support wall and the second support wall.

23. The terminal of claim 21, wherein the contact support includes first support fingers extending from the first support element and second support fingers extending from the second support element, the first support fingers extending along the first support blades, the second support fingers extending along the second support blades, the first and second fingers configured to interface with the cable.

24. A terminal comprising:
a terminal body extending between a mating end and a terminating end, the mating end having a mating interface, the terminating end having an insulation displacement contact;
the insulation displacement contact including a first contact element and a second contact element having a cable slot therebetween configured to receive a cable, the insulation displacement contact having an exterior opposite the cable slot, the first contact element including a first lateral wall and first blades extending from the first lateral wall toward the second contact element, the second contact element including a second lateral wall and second blades extending from the second lateral wall toward the first contact element, the second blades being aligned with the corresponding first blades across the cable slot, the first and second blades configured to pierce an insulator of the cable to electrically connect to a conductor of the cable, the insulation displacement contact having a base wall between the first and second lateral walls; and
a contact support having a cladding layer clad to the exterior of the insulation displacement contact, the cladding layer extending along the first contact element and the second contact element, the cladding layer including a first support element extending along the first lateral wall and a second support element extending along the second lateral wall, the cladding layer including a cover element extending along the base wall, the first and second support elements holding the first and second lateral walls relative to each other to resist widening of the cable slot.

25. The terminal of claim 24, wherein the cladding layer includes support fingers extending along the first and second blades.

26. The terminal of claim 24, wherein the terminal body is manufactured from a first material and the cladding layer is manufactured from a second material having a higher modulus of elasticity than the first material.
